(19) United States
(12) Patent Application Publication
(10) Pub. No.: US 2022/0036478 A1
(43) Pub. Date: Feb. 3, 2022

(54) Social financial platform and related methods.

(71) Applicants: Robert J. Chandler, San Antonio, TX (US); Mike Milan, San Antonio, TX (US)

(72) Inventors: Robert J. Chandler, San Antonio, TX (US); Mike Milan, San Antonio, TX (US)

(21) Appl. No.: 16/944,009

(22) Filed: Jul. 30, 2020

(51) Int. Cl. G06Q 40/00; G06Q 50/00

(52) U.S. Cl. CPC G06Q 40/125; G06F 21/31; G06Q 50/01

(57) ABSTRACT

Disclosed are methods and apparatus for a web and mobile data analysis social network software application called Snopsis.

### CROSS-REFERENCE TO RELATED APPLICATIONS

Not applicable.

### INCORPORATION BY REFERENCE

This document incorporates by reference a system architecture and design document submitted concurrently with the application.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of devices or systems including automated analytics software tools.

### Background of the Invention

Data are generally characteristics or numerical information that have been collected through observation. When understood in context or processed, data can be analyzed and transformed into information. Often, data analysis yields visual deliverables like graphs or images that can be used to better present data related information to interested individuals. Because data allows for information to be quantified and qualified, it can be used for more precise evaluation, informed process improvement, problem solving, decision making, and the like.

The incredible utility of data in everyday life is apparent. Indeed, data is being used more and more to drive decisions, plans, and evaluations of businesses, researchers, governments. It is also becoming clear that data-driven approaches tend to lead to better outcomes than decisions that are driven by emotion or intuition because data-driven decisions can take account for far more information than a personally driven decision in an unbiased way. Although human observational decision making has a quantified and qualified dimension, it lacks the sheer processing power that is so readily available in modern computers.

The move from an intuitive approach to data driven approach in so many fields and organizations has been caused in large part by the computing revolution of the last 30 years. In a short amount of time computers went from being an obscure machine to a ubiquitous device. The proliferation of computers has had a twofold impact on this shift in approach. 1) Computers have created a lot of data from observing user activity. 2) Computers have democratized the tools necessary for processing all this new data. The simultaneous creation of so much new data and processing tools has created large opportunities and challenges for those involved with data analysis.

Today, data is generated by and flowing through organizations at an unprecedented speed and volume. Although this data presents mostly positive benefits, there are unique challenges associated with processing this data. These unique challenges are compounded by the fact that data analytics is a relatively new field resulting in a lack of experienced professionals and tools which can be employed to organize, process, and analyze data. The challenges themselves stem from the sheer volume, variety, and velocity of the data. In some cases, there is too much data. In other cases, it is unorganized, or it is in too many places. In under even more complex circumstances, processing the data may be so strenuous that the data may be obsolete by the time insights can be gathered or appreciated. Because of these challenges, incredible insights and findings have failed to be realized because they remain largely buried in a sea of unprocessed data.

Small businesses disproportionately fail to capitalize on the insights that may be gathered from their data. This is likely due to data-oriented professionals and tools being even further out of reach for small businesses. Small business data may provide information about financial mismanagement, company valuation, customer metrics and the like. It is also the case that many small businesses fail because they lack a data driven approach. Small business data remains largely unprocessed and important findings remain buried in the noise of unsorted data. In the data there may also exist indications of unmitigated problems in their infancy. If small businesses could process this data, there would be opportunities for the business to mitigate efficiency and financial mismanagement problems long before they become capable of bankrupting the business.

Data analysis often produces numerical results. Although numbers are important, they are ambiguous without context. Data analysis deliverables also are geared to a more technical audience which may leave most stake holders or team members unaware of the significance of the deliverables. So, another important aspect of data analysis is packaging insights so that they can best inform decision makers within a business.

Another important aspect of data analytics is information distribution. If information is not presented timely to the right people, the utility of the insights is lost. Information must get to the correct people and be presented coherently so that these people can make an informed decision. Thus, a need exists for a tool which properly distributes data analysis deliverables and its qualifying information to all parties within an organization.

Attempts have been made at business focused digital data analytics platforms such as those offered by ClearStory.com (http://www.alteryx.com/),InsightSquared (https://www.insightsquared.com/), and Klipfolio (http://www.klipfolio.com/). All of which have some merits. ClearStory.com offers a software that allows workers to manipulate, process, and gain insights from data. This technology is reserved for larger companies, focuses primarily on data, and is not designed for small remote teams. InsightSquared is a web-based platform that aggregates sales and marketing data to provide insights to help managers improve revenue performance. Klipfolios is a data processing platform which allows for data integration, analysis, and visualization. The platform also allows for deliverables to be shared via email, Slack, and the like.

Considering the attempts, there is still no integrated tool or system which allows for small businesses and remote teams to process data, create deliverables, combine these findings with qualified information about a business, and distribute the results. However, such a tool or system could increase the earnings and longevity of small businesses. Thus, a need exists for such a tool or system.

### LISTING OF RELATED ART

A listing of related art is provided below:
AU2018350897A1 to Harding discloses, “Memory allocation in a data analytics system.”
CN103677910A to Cai discloses a, “Calculator starting method and system and application program.”
EP1594072A2 to Liu discloses, “A system and method for GUI supported specifications for automating form field extraction with database mapping.” JP4314221B2 to Kinrin discloses a, “Structured document storage device, structured document search device, structured document system, method and program.”
KR01648318B1 to Krugrik discloses, “Content suggestion for posting on communication network.”
TW201437930A to Lee discloses a, “Enterprise social networking service system with multi-level organization management.”
US7054841 to Tenorio discloses, “Document storage and classification.”
US7194457 to Alavi discloses a, “Method and system for business intelligence over network using XML.”
US7499879 to Aupperle discloses a, “Cooperative e-business complex.”
US8364013 to Nijim discloses, “Content bookmarking.”
US8510259 to Binstock discloses a, “XBRL database mapping system and method.”
US8606813 to Bedell discloses a, “System and method for function selection in analytic processing.”
US9087178 to Lowe discloses a, “System and method for posting content to network sites.”
US9563712 to Hanson discloses, “Computer implemented methods and apparatus for providing internal custom feed items.”
US10210586 to Odio discloses a, “Composited posting interface for social networking system.”
US10361990 to Verma discloses, “Computer implemented methods and apparatus for integrating a social network information feed with a network communications application.”
US20050177477A1 to Arfhavanifard discloses a, “‘Time clock’, ‘timesheet’ and ‘payroll calculator’ software.”
US20120109954A1 to Whit discloses, “Ubiquitous bookmarking.”
US20140006125A1 to Meegan discloses a, “Method and system for creating electronic business referrals with cloud computing from social media sites.”
US20140129678A1 to Herman discloses, “Business networking information feed alerts.”
US20140204116A1 to Maurer discloses a, “Rendering a map using style identifiers.”
US20180330288A1 to Harding discloses a, “Method of data aggregation for cache optimization and efficient processing.”
US20200097948A1 to Sheets discloses, “Secure remote payment transaction processing.”
US20200126171A1 to Jabra discloses a, “System and method for payment tracking of purchases.”
WO2015073641A3 to Bailiang discloses a, “Personalization of map content via an application programming interface.”
WO2017044119A1 to Mahasheta discloses a, “Graph database and relation database mapping.”
WO2017092126A1 to Qian discloses a, “Information processing method and device.”

### SUMMARY OF THE INVENTION

In view of the foregoing, an object of this specification is to disclose a mobile business analytics tool, including a social financial platform. It is another object of this specification is to disclose a web business analytics tool, including an improved software platform. Yet another objective of this specification is to disclose a social network equipped business analytics software platform. Still, it is an object of this specification is to disclose a QuickBooks, Xero, and Sage compatible business analytics software platform. Also, an object of this specification is to disclose a business analytics software platform with customer management capabilities. Additionally, an object of this specification is to disclose a business analytics software platform with vendor management capabilities. Another object of this specification is to disclose a business analytics software platform with customer mapping capabilities. Finally, an object of this specification is to disclose a business analytics software platform with vendor mapping capabilities.

Other objectives of the invention will become apparent to those skilled in the art once the invention has been shown and described. These objectives are not to be construed as limitations of applicant's invention but are merely aimed to suggest some of the many benefits that may be realized by the apparatus of the present application and with its many embodiments.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is an image of a login page;

FIG. 2 is an image of a data flow chart page;

FIG. 3 is an image of an activity feed Page;

FIG. 4 is an image of a post page;

FIG. 5 is an image of the post page;

FIG. 6 is an image of the create post page;

FIG. 7 is an image of a post;

FIG. 8 is an image of a to-do list page;

FIG. 9 is an image of a custom calculator page;

FIG. 10 is an image of the custom calculator page;

FIG. 11 is an image of a Business Impact Center Map page;

FIG. 12 is an image of a Business Impact Center distributer page;

FIG. 13 is an image of a navigation page;

FIG. 14 is an image of a notification center page;

FIG. 15 is an image of a training video page;

FIG. 16 is an image of a document center page; and,

FIG. 17 is an image of document center folder page.

In the figures each component of the synopsis platform in the figures is labeled and indicated by the numeral as shown on the list below;
1—login page;
101—login input field;
102—password input field;
103—login button;
104—“Forgot Password” link;
201—customer accounting file;
201a—QuickBooks;
201b—Xero;
201c—Sage50 account;
202—company administrator;
203—Snopsis administrator;
204—Snopsis user;
205—document deliverable;
206—Snopsis database;
3—activity feed page;
301—scrollable activity feed;
302—post;
302a—date range;
302b—calculation;
303—to-do list;
303a—action;
304—milestone;
305—add milestone icon;
4—post pages;
401—“like” icon;
402—“comment” icon;
403—“bookmark” icon;
501—financial ratios;
6—create post page;
601—post image field;
602—post title field;
603—post description field;
604—“slide up to submit” icon;
701—post title;
702—post description;
703—media link;
704—post date;
705—user handle;
8—complete to-do list page;
801—ratio chart;
802—“on target” field;
803—“industry average” field;
9—calculator custom create section;
901—QB column names;
902—number inputs;
903—date range;
904—“save” icon;
905—math functions;
906—calculation;
10—saved calculations section;
1001—search field;
1002—formula dropdo vn list;
1002a—saved formulas;
1002ai—formula name;
1002aii—formula description;
11—Business Impact Center Map page;
1101—vendor icon;
1102—customer icon;
1103—map;
1104—vendor customer list;
1105—vendor customer transaction record;
1105a—transaction record;
1105b—“Add To-Do List” icon;
12—Business Impact Center Transaction Page;
13—navigation page;
1301—to-do list tile;
1302—million-dollar calculator tile;
1303—Business Impact Map tile;
1304—documents tile;
1305a—home icon;
1305b—training icon;
1305c—company icon;
1305d—settings icon;
14—notification center page;
1401—notification;
1401a—notification title;
1401b—notification description;
1401c—seen mark;
1401d—notification time stamp;
15—training page;
1501—training video program,
1502—“Click Here” link;
16—document center page;
1601—document folders;
1601a—document folder title;
1601b—document counter;
17—document center folder list page;
1701—document list;
1702—documents;
1703—control tab;
1703a—“delete” icon;
703b—“email” icon; and,
1703c—“post” icon.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

Disclosed is a preferred embodiment of improved devices, systems and automated analytic software tools and related methods. Suitably, the disclosed preferred embodiment may be referred to throughout this document as “Snopsis”. In a general operation, Snopsis collects and analyzes small business financial and non-financial data to identify hidden patterns that lead to business issues and allows a collective team to collaborate and take action on these issues in real time, before they are critical problems. The details of the preferred embodiment are described with relevance to the figures. Suitably, the figures presented are in the form of graphical user interfaces of an exemplary system installed on a mobile device or personal computer.

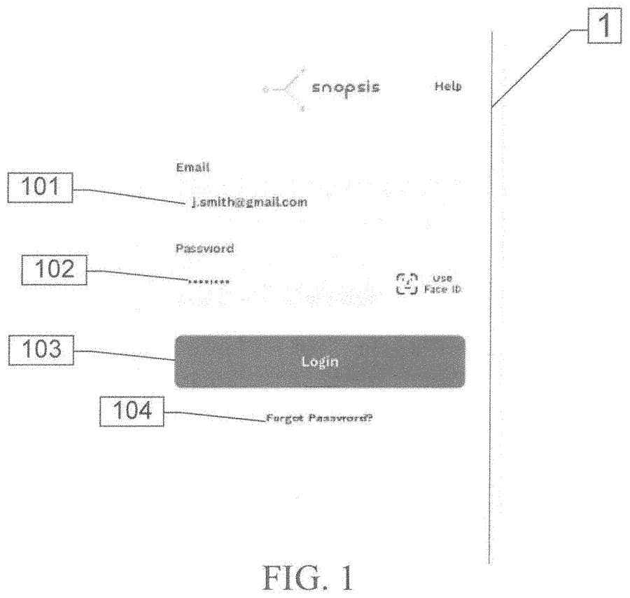

FIG. 1 is an image of a login page 1 or user interface on a mobile device. This page may contain a login input field 101, and a password input field 102. Once the require fields have been filled, a user may press a login button 103. Snopsis requires that a user start by creating a user profile. Snopsis may also sign a user in via Face ID. If a user forgets their password, they may use a “Forgot Password” link 104 to recover their password.

In on example, a user may sign up for the user profile, complete a profile, and connect to an accounting data source such as QuickBooks 201a. In the user profile, the user should be able to change their name, a company name, their subscription, and invite other users. The user may be prompted to answer questions about their company in order to complete their profile. Participants may be given varying permission levels and functionality regarding their ability to post, view, edit, delete, or create information or content inside Snopsis. The options for permission levels may be Starter, Pro, Expert, and Trusted Advisor.

Featured thereafter, may be a user list page (not shown). This page may show all invited users and their roles. The shown available roles may be Admin, Advisor, Manager, and Employee. The available permissions to assign roles may be provided by Snopsis.

The administrator ole may be allocated specific privileges. The administrator may have access to all features and be able to grant specific permissions to other users. The administrator may manage user profiles and notifications. The administrator may have access to controlled information such as company lists, plan details or user statistics. User statistics may include location, industry, time stamps. Lastly, administrators may have the ability to add a post 302 to a user's activity feed 301 or create a new milestone 304.

Snopsis may also feature data slicing functionalities. Data slicing is a feature that gives administrators agency over who has access to what data. In Snopsis specifically, administrators may assign data field access to individuals or groups. The data slicing feature intends to give the right person the right information at the right time. Data slicing creates a second set of position specific data inputs. Data slicing keeps the number of individuals who have uncontrolled access to QuickBooks 201a to a minimum and eliminates the step of creating redundant employee specific spreadsheets.

Data slicing pertains to individuals differently dependent on their position. In terms of a sales team, the data slicing may give access to sales accounts and payroll data of the sales team to a sales manager. Access to sales accounts and payroll data allows for accounting, sales, and the executive team to use the same data to evaluate performances. An accounts relievable clerk may be given access to customer invoice information in a plurality of business impact center pages 11 or 12. With data slicing the accounts receivable clerk may keep on top of overdue invoices or look up paid invoice information without accessing QuickBooks 201a. The data slicing feature may give marketing teams access to a sales account and marketing expense accounts. Maintenance teams may be given access to repairs and maintenance cost data.

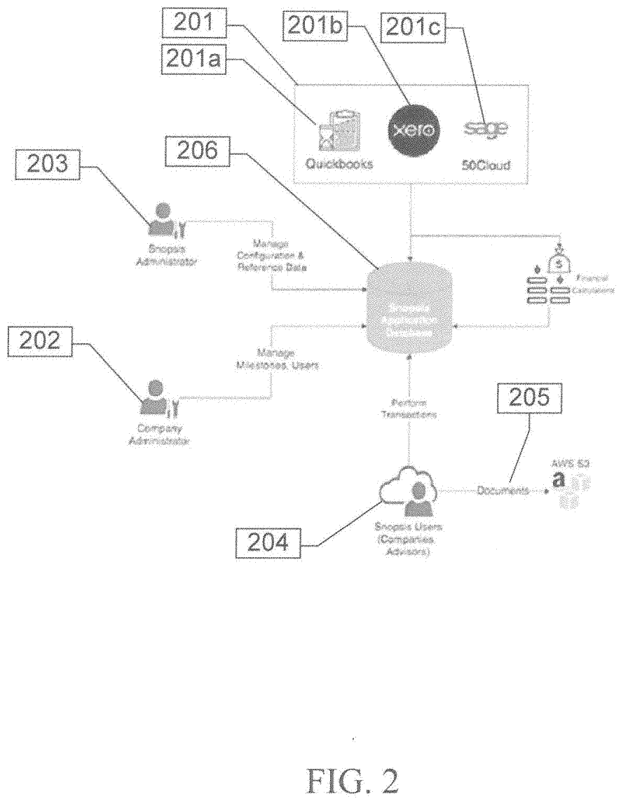

FIG. 2 is an image of a data flow chart. As shown a Snopsis database 206 integrates data from a customer accounting file 201, financial calculations, company administrators 202, Snopsis administrators 203, and Snopsis users 204 to produce document deliverables 205. Data from the customer accounting file 201, such as QuickBooks 201a (“QB”), may be imported into the Snopsis database 206. During a data mapping process, the user may be presented with a list of their QB fields (not shown) and map them to a plurality of Snopsis data fields (not shown). The user may only be required to complete mapping the first time a QB account 201a is connected to Snopsis. In subsequent data updates, the user may be prompted to map only new fields that do not have an existing mapping. In the mobile version of Snopsis, the user may see directions to connect their QuickBooks account 201a to Snopsis. The mapped data will be used to run calculations. Snopsis may aggregate up to five years of data. Snopsis may also store QB files 201a in a central folder. A full list of a plurality of data feeds being pulled from QB files 201a is shown below.

The following data feeds may be provided from QuickBooks Online at an individual account level on an ongoing basis:

1. Balance Sheet;

2. Income Statement;

3. Cash Flow Statement;

4. Profit & Loss Statement;

5. Transaction List;

6. Open Invoice Report;

7. AP Aging Report;

8. AR Aging Report;

9. Inventory List;

10. Vendor List;

11. Customer List; and,

12. Employee List.

In a web version of Snopsis, the user may have the ability to connect their Xero account 201b or Sage50 account 201c to their Snopsis profile. Once either account is connected, Snopsis may import data into the Snopsis database. The user may be presented with a list of their Xero fields (not shown) or Sage50 fields (not shown) and map them to Snopsis data fields. The user will only be required to complete mapping the first time an account is connected to Snopsis. In following data updates, the user may be prompted to map only new fields that do not have an existing mapping.

In the mobile version of Snopisis, the user may see directions to connect their Sage50 201c and Xero accounts 201b through the web application. The mapped data may be used to run calculations.

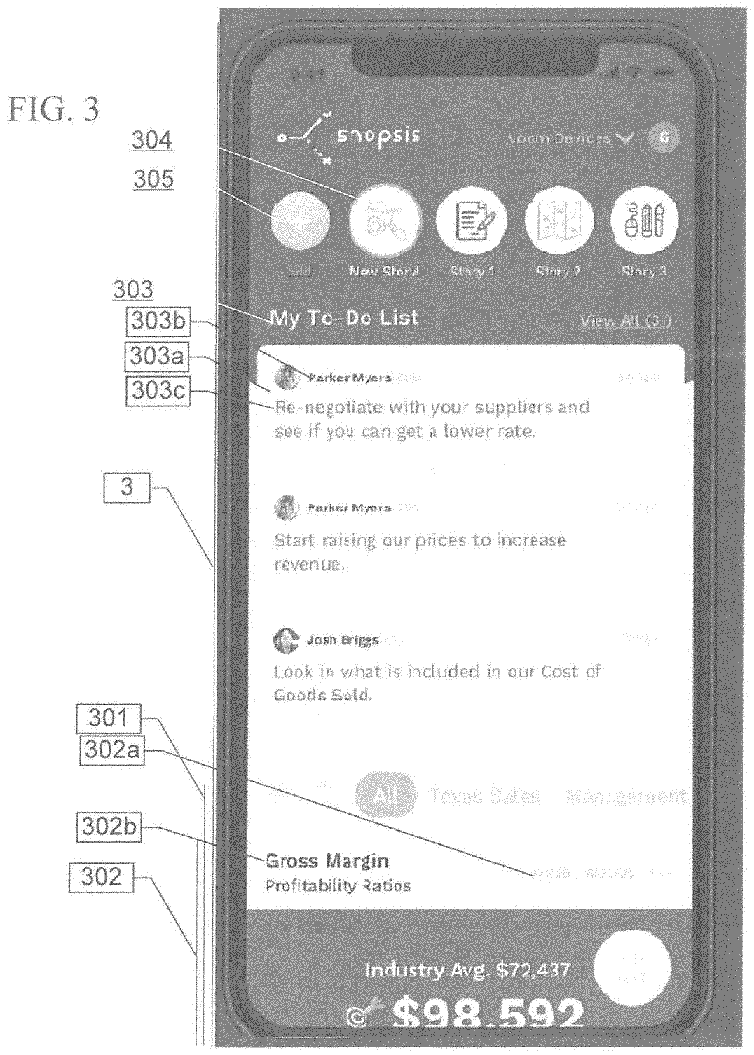

FIG. 3 is an image of an activity feed page 3. Snopsis produces the results of the analysis in the form of a scrollable activity feed 301. The activity feed 301 may be updated based on the frequency of a Snopsis defined formula. For example, a new post 302 may be created for a formula 1002a based on a scheduled frequency. Posts 302 may be user or system generated. Posts 302 may contain the following information such as an image, a calculated number, an industry average, a graph or chart, a metric change, or a calculation.

The user may see information about the post 302 such as a date range 302a of the calculation, a name of the calculation 302b, and a short description (not shown). The user may have the following options on the post: bookmark, see calculation, switch to graph, or add to a milestone 304. The user may have options to “like” and “comment” on the posts 302. A user can tag other users within their company by using a handle (@followed by a name) in the comment box.

The user may search for a post title 701 or a post description 702 to find a specific post 302. The user may be able to create their own post 302. When a user creates a post 302, they can add a title, a description, an image, a video, or a text block. The user can create a post 302 from a plurality of formulas 1002a created in a calculator custom create section 9.

Shown on the top of the Activity Feed Page 9 there is the milestones 304 feature. With the milestones 304, the user can identify critical events that help tell a company's story in terms of financial data. The system ask the user questions about their company, and the answers can be added to the milestones 304. Additionally, the system will highlight important financial information about the company and present it as an option to create a milestone 304. The user may also be able to add their own milestones by way of a add milestone icon 305.

The information that may be contained in milestones 304 may outline whether trends are positive or negative, a title, a description, a date of the milestone 304, and an icon or image. The user should be able to edit, remove, or update all existing milestones 304.

Snopsis may also identify company valuation changes, achievement of sales records, a purchase of new equipment, and the like. The user may also identify non-financial events that help explain relevant financial data. Examples of these non-financial events may be that a new VP of Sales was hired, or an outcome of an advertising campaign.

Another feature of the activity feed shown in FIG. 3, is a to-do list 303. Here, Snopsis may give a suggestion or an action 303a as how to improve specific financial metrics or circumstances. The user may choose to add these actions 303a to the to-do list 303 so that either the user or a team member 303b can do tasks pursuant to the actions 303a. The user may be able to create their own actions 303a with an action title 303c and short description (not shown). The user should be able to set a due date and assign actions 303a to others.

Actions 303a derived from Snopsis recommendations may have a checkmark (not shown) that allows the user to add that item to their respective to-do list 303. The to-do list 303 may be shown in part on the homepage and provide a link to a complete to-do list 801. The user may be able to complete the action 303a from the activity feed page 3. In the full view of a complete to-do list 801, the user may see a graph or a ratio chart 801 that may be associated with the action 303a if it was created from a specific post 302.

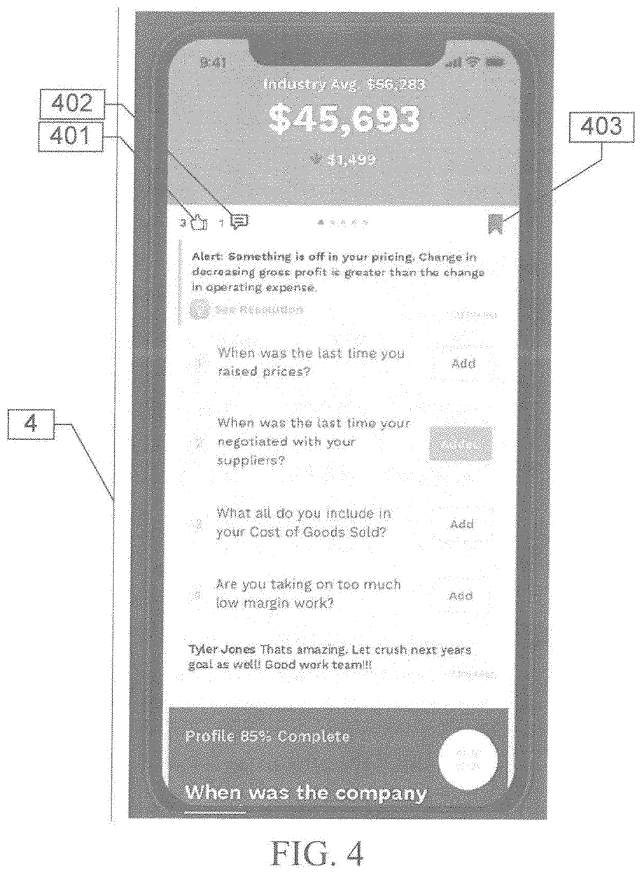

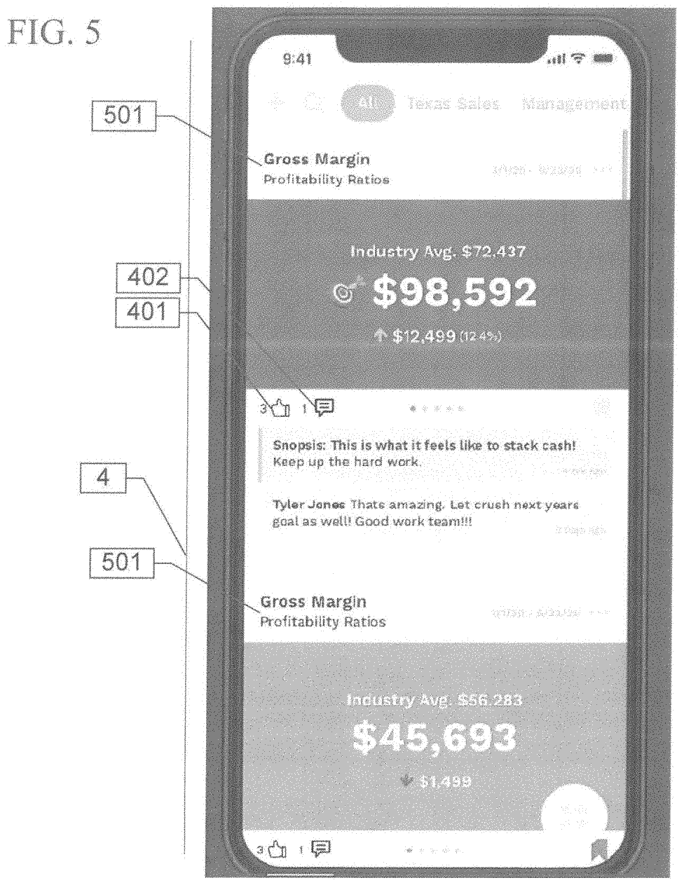

FIGS. 4 and 5 are images of post pages 4. The post page 4 is dedicated to calculating and displaying financial ratios 501. Here, users may comment, like, or bookmark the post via a “like” 401, a “comment” 402, or a “bookmark” icon 403. If the post 302 is bookmarked, it is pinned to a dashboard (not shown). On a desktop the dashboard behaves like a regular business dashboard version of the app. On a mobile device the dashboard behaves like an activity feed 301.

Snopsis may allow a user to bookmark pages. Bookmarking saves posts 302 to a bookmark section (not shown) of the platform. The user can add and compile bookmarked pages by creating a new bookmark and providing a bookmark name. The user should be able to bookmark a specific post 302 to their bookmark page. In the bookmark page, the user may be able to reorder or remove posts. The user may be able to share their bookmarked pages with other users within their company.

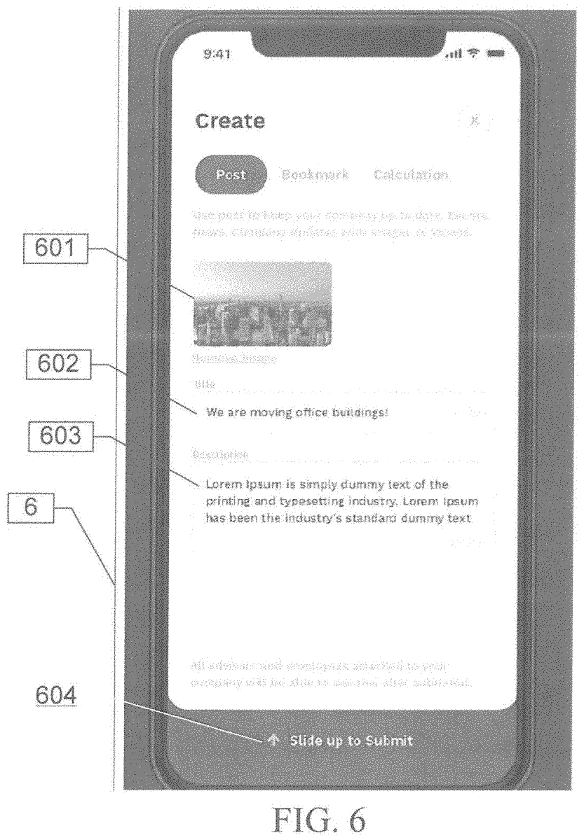

FIG. 6 is an image of the create post page 6. Users may create their own posts 302 in the create post page 6. A user may create a post 302 by adding content to an image field 601, a title field 602, or a description field 603, with images, videos, and text respectively. When the fields are filled a user may use a “slide up to submit” icon 604 to publish their post 302. Posts 302 may be used to connect non-finance workers with finance workers within a company since anyone may create a post 302. Hypothetically, posts 302 may allow anagement to tell a team about an event or deadline or acknowledge an exceptional individual effort on a project.

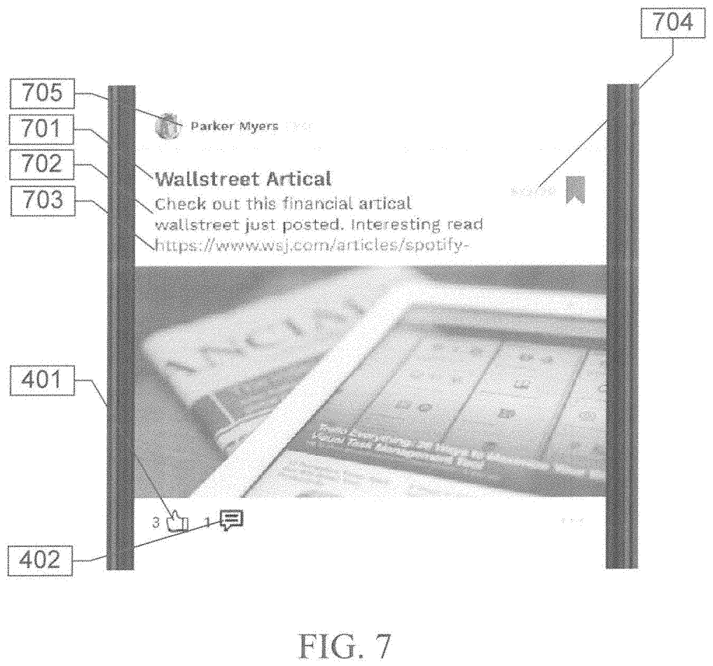

FIG. 7 is an image of a post 302. The post 302 has a title 701, description 702, link 703, date 704, user handle 705, “like,” 401 and “comment” icons 402.

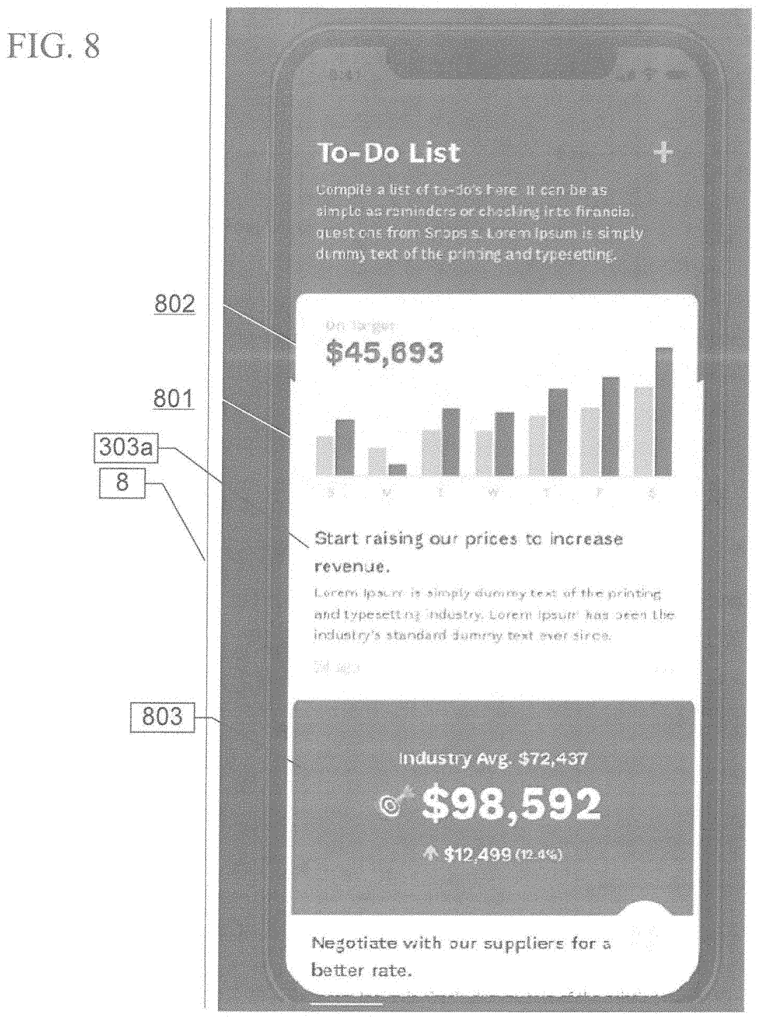

FIG. 8 is an image of a Complete To-Do List Page 8. Here, the user may create actions 303a, assign them to other users, or check their status by refreshing the ratio chart 801 which may be associated with the action 303a. The chart 801 may indicate if the company is on target via a “on target” field 802 or indicate where the company stands relative to competitors with an “industry average” field 803. To remove an action 303a from the list, one may simply mark the action 303a as complete.

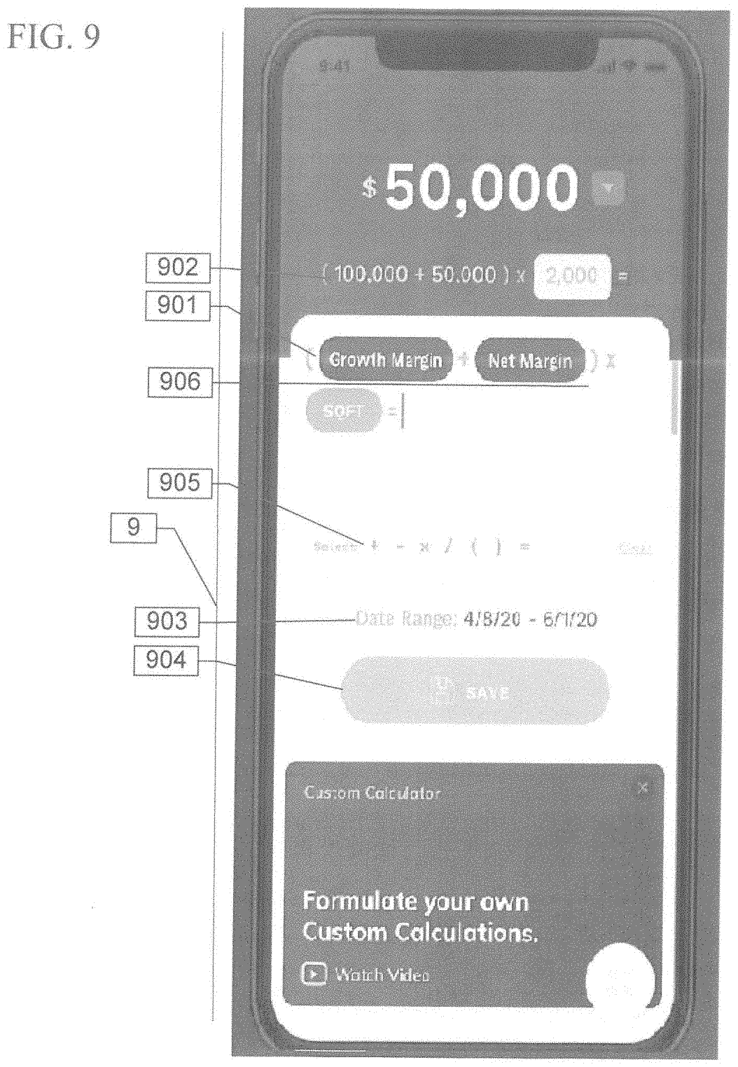

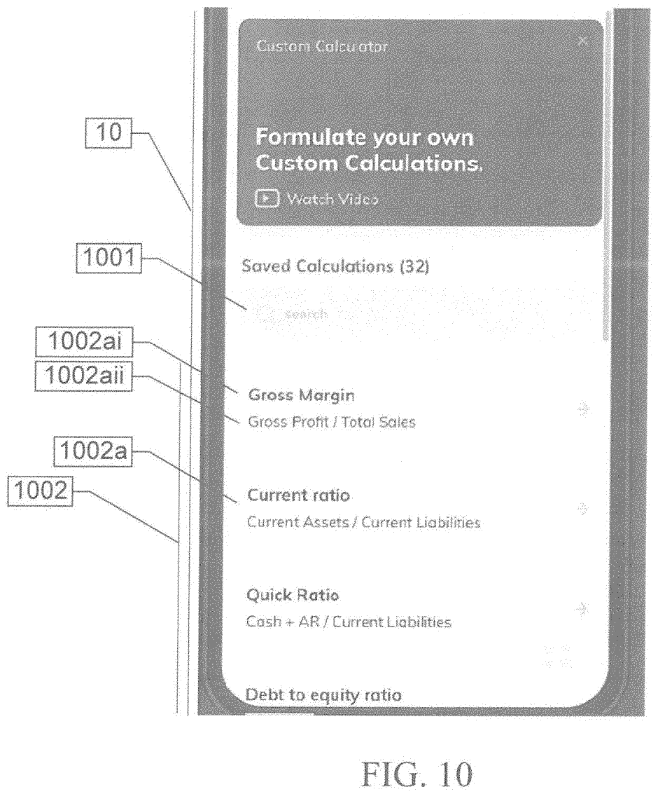

FIGS. 9 and 10 are images of custom calculator pages. Snopsis has custom calculator features because it is perhaps impossible to pre-load an app with every calculation a user may want to do. A calculator custom create section 9 is dedicated to creating, sharing, and saving formulas. In the create section 9 the user may create calculations using a plurality of QB column names 901. Above the QB column names 901 is the same calculation with correspondent number inputs 902.

Also shown are a plurality of math functions 905. The custom calculator 9 may allow users to select data from QB column names 901 and create formulas 1002a using addition, subtraction, multiplication, division, and parentheses. At the top of the custom calculator page 9, the formula 1002a may be displayed as it is created by the user. Seen below is a date range 903 below, and further below, is a “save” icon 904. When a user presses the “save” icon 904, the calculation 906 will be stored to a “saved calculations” section 10 shown in FIG. 10. Snopsis may also be preloaded with some common formulas 1002a stored in the saved calculations section 10 shown in FIG. 10. which can be searched by name via a search field 1001. A formula matching feature proposes to match formulas 1002a based on the fields selected by the user and show a warning message that the formula 1002a may already be preloaded in the app.

If the user wants to use a data element (not shown) that is not available in QB, the user has the option to add a custom field and number that may be stored in the synopsis database and added to a formula dropdown list 1002.

As shown in the saved calculations section 10, the user may have the option to save, name, and add a description for a plurality of formulas 1002a. The user can select and recalculate saved formulas 1002a. The user may also run, edit, or rename existing saved formulas 1002a. From the formula list 1002, the user may be able to search by a formula name 1002ai or a formula description 1002ai i if one is provided. The user may select a saved formula 1002a to calculate a number, a decimal, or a percentage. After calculating, the user may select one of the options for a graphical or chart representation of their data. The user may have the ability to create posts 302 from the saved formula 1002a.

Another formula Snopsis may come preloaded with is a Valuation Estimator. The Valuation Estimator proposes to show the company valuation to the user. The valuation will be calculated based on the following formula: EBITDA+Capital Expenditure+Owner's Expenses=Free Cash Flow*Multiple=Value−Funded Debt=Equity Value. The user may be presented with the calculation and be able to perform a “what if calculation” by changing each field in the calculation and recalculating the valuation based on the changes. The “what if calculation” may help the user identify metrics most fundamental to the company valuation. The system may save, store, and chart historical valuation calculations so the user can track how their valuation has changed over time. Recommendations or actions 303a will also be provided to help a user increase the company valuation. These recommendations can be added to the to-do list 801.

The following saved formulas 1002a may come preloaded on Snopsis:

1. Current Ratio;

2. Quick Ratio;

3. Debt to equity ratio;

4. Gross Margin;

5. Net margin;

6. Sales to Assets;

7. EBITDA;

8. ROA;

9. ROI;

10. Inventory days;

11. AR days;

12. AP days;

13. DSCR;

14. Days Cash on Hand;

15. Mis-Matched financing;

16. Customer Concentration;

17. Trends;

18. Net Cash Flow;

19. Potential Sales;

20. Potential Gross Profit;

21. Potential Net Profit;

22. Potential Inventory;

23. Potential Accounts Receivable;

24. Potential Accounts Payable;

25. Cash Leak Map;

26. Working Capital Requirement—Inventory Company;

27. Working Capital Requirement—Service Company;

28. LTD Availability;

29. Operating Cash Shortage; and,

30. Working Capital.

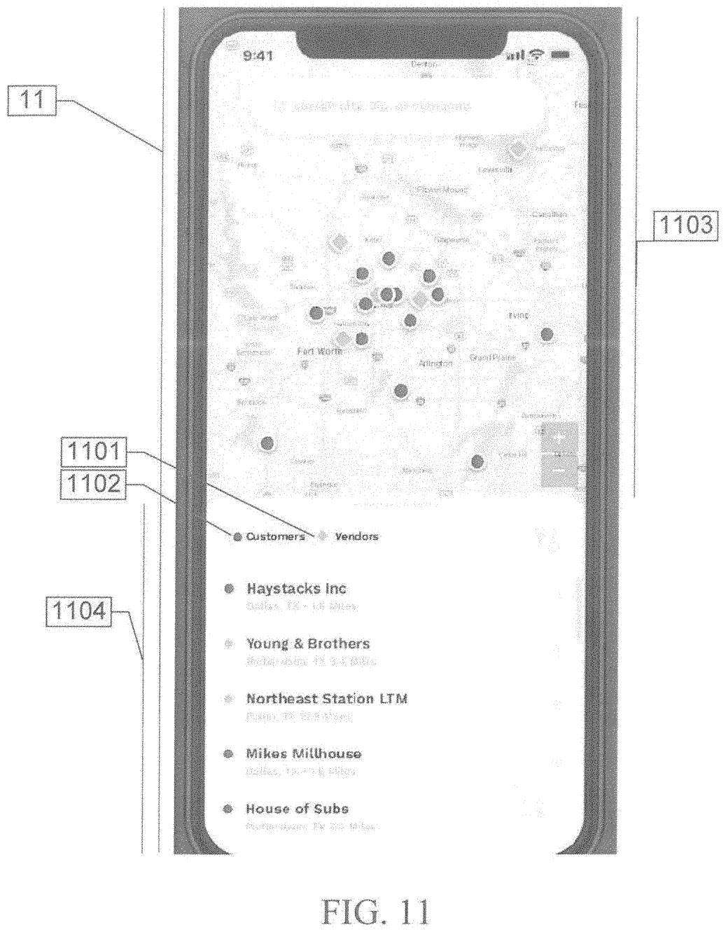

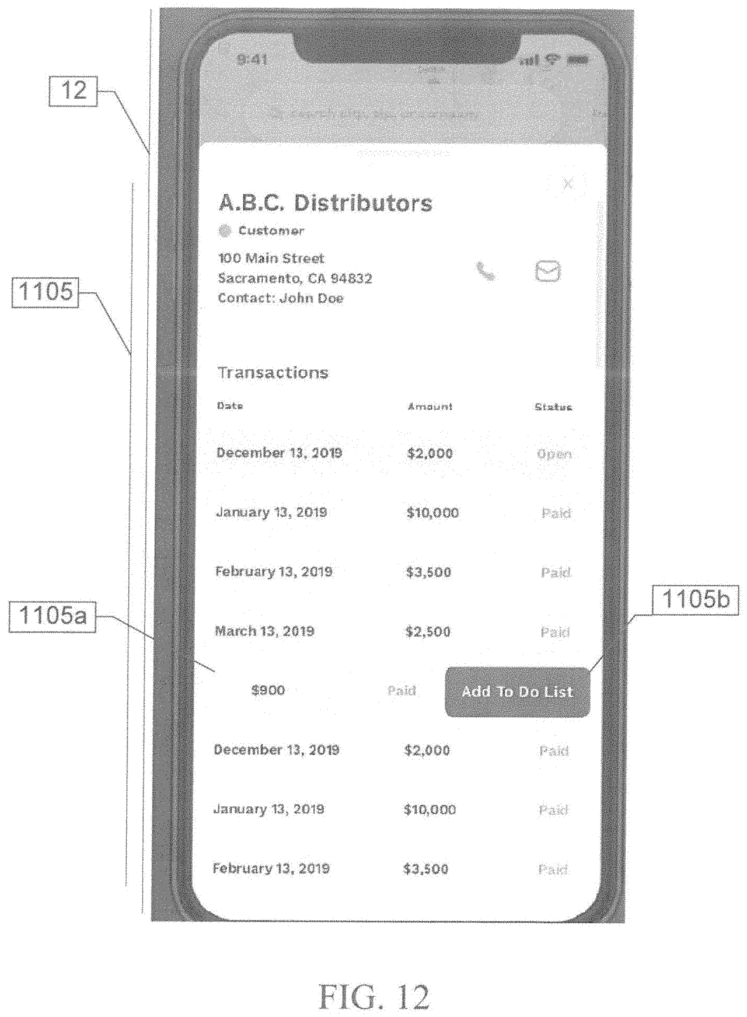

FIG. 11 is an image of a Business Impact Center Map page 11. FIG. 12 is an image of a Business Impact Center Transaction page 12. The Business Impact Center is a Snopsis feature that provides information and insights about a plurality of vendor and customer interactions and the respective locations of the vendors and customers via a plurality of vendor icons 1101 and a plurality of customer icons 1102. This page may provide a map 1103 view (Google API) with the locations of customer 1102 and vendor icons 1101 plotted. The map 1103 specifically allows the user and the company to understand their physical reach and impact. The Business Impact Center Map page 11 may also demonstrate historical reach and impact by displaying the map 1103 at different times.

Vendor icons 1101 and customer icons 1102 may be color coded on the map 1103 allowing the user to easily distinguish between the two. As shown, vendor icons 1101 are orange and customer icons 1102 are blue. The user may have the ability to filter selected icons and see only vendor icons 1101 or only customer icons 1102 on the map 1103. Also shown is a vendor customer list 1104. The vendor customer list 1104 may include information like a name, location, or distance to a specific vendor or customer.

By clicking on a customer icon 1102 or vendor icon 1101 on the vendor customer list 1104, a user may see a vendor customer transaction record 1105 listing open and closed transactions with that entity. A user may add a transaction record 1105a to the to-do list 303 by first swiping left then pressing a “add to-do list” icon 1105b. In this section, the user may also access an invoice (not shown), make a call (not shown), or send a reminder email (not shown). Snopsis also may alert a customer when an invoice or bill is due.

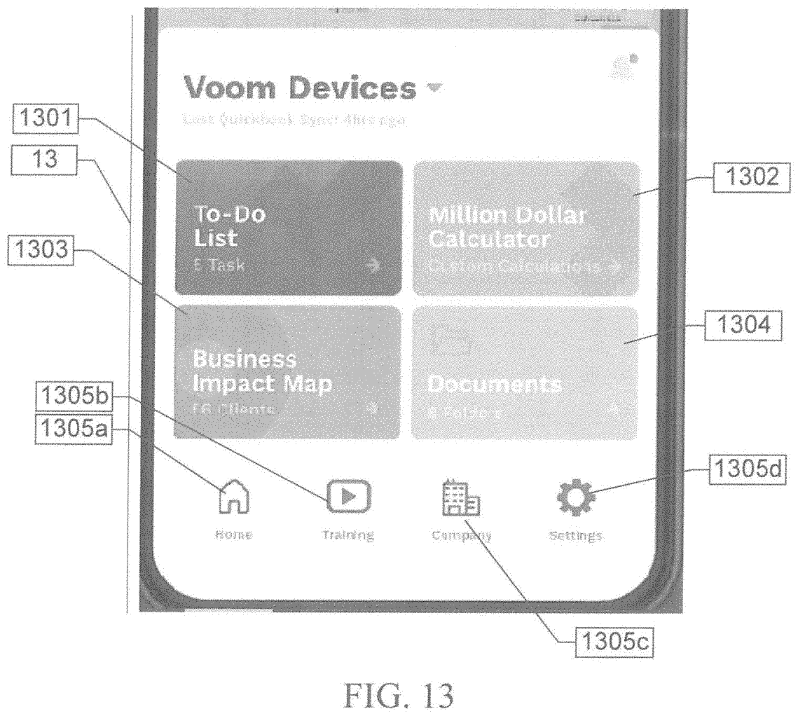

FIG. 13 is an image of a navigation page 13. Shown on the navigation page 13 is a plurality of tiles, specifically, a to-do list Tile 1301, a million-dollar calculator tile 1302, a Business Impact Map tile 1303, and a documents tile 1304. Below the tiles is a navigation bar 1305 which contains a plurality of navigation icons. Shown are a home icon 1305a, a training icon 1305b, a company icon 1305c, and a settings icon 1305d. The user may use either the icons or the tiles to navigate to different Snopsis pages.

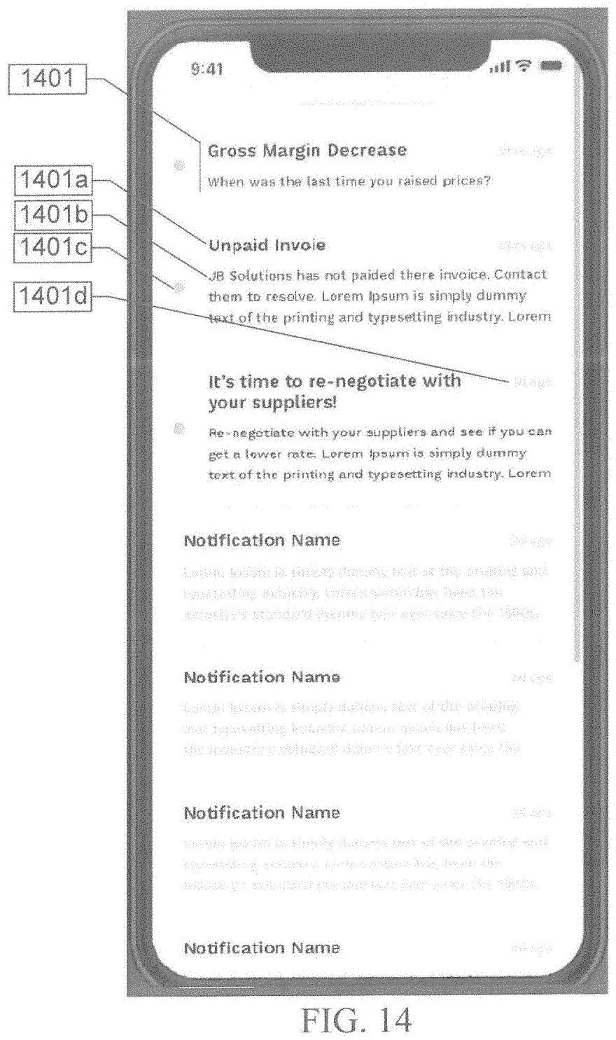

FIG. 14 is an image of a notification center page 14. If the results of an analysis need immediate attention, an alert, or a notification 1401 may be sent to the user. Shown on the notification center page 14 are a plurality of notifications 1401. The notification 1401 may be comprised of a notification title 1401a, a notification description 1401b, a seen mark 1401c, and a notification time stamp 1401d. These notifications 1401 will be driven by comparison of the financial ratios 501 and industry averages or user set thresholds. The notification 1401 may be shown on a post 302 in a different color depending on the connotation or context of the notification 1401. If the notification 1401 is extremely pressing, the user may be notified on their mobile device. These notifications 1401 may be managed in the notification center 14. Further, there may be a badge counter (not shown) in the notification center 14 to show notifications 1401 for comments aimed at the user and the like.

When the notification 1401 is negative, Snopsis may add a recommendation or action 303a regarding how the notification 1401 may be resolved. The user may be able to select a “see resolution” icon (not shown) to get the access to the action 303a.

Snopsis may allow users to control notification settings. The user may have the ability to turn on and off different types of notifications 1401. If the user has multiple companies which use Snopsis, the user may be able to set each company's notification settings individually.

Specific notifications may include:

1. Anomalies in QB data.
a. By default, if the Snopsis formula calculation total increases or decreases by 20%, a notification should be triggered;
b. The user should be able to change the percentage threshold for each calculated total;
c. New customer found;
d. New vendor found;
e. Largest sale recorded;
f. Record profit month/quarter/year;
g. Record sales month/quarter/year; and,
h. Sales routinely drop in month.

2. User is tagged in comment.

3. Credit card declined/expired.
a. Only goes to person who paid for account.

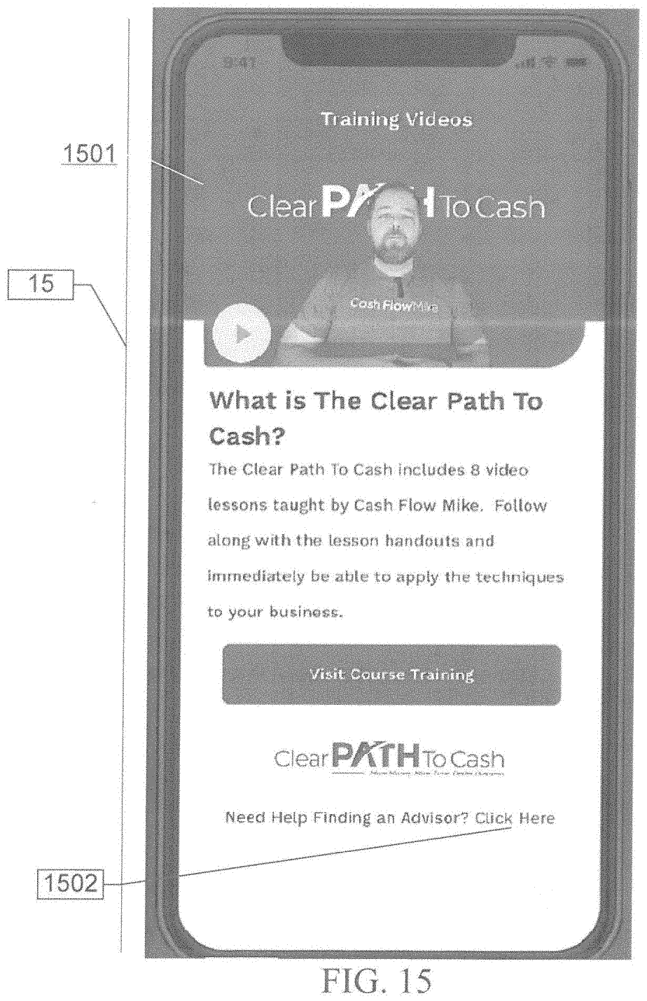

FIG. 15 is an image of a training page 15. The training page 15 may also provide access to a video training program or an advisor. The training video page 15 may show a training video program 1501 in the center. A “click here” link 1502 can be found at the bottom of the training page 15 which may be used for users to find an advisor. After clicking the “click here” link 1502, the user may be shown a list of advisors (not shown) with advisor details (not shown) which may include an advisor name, company name, phone number, email address, their LinkedIn URL, or a company logo.

The Advisor user will have the ability to opt in and be part of the advisor list (not shown). If the advisor opts in, they may need to provide professional information. The user may be able to search by zip code or by advisor name to filter the advisor list.

The video program 1501 shown is called, “The Clear Path to Cash—8 lessons to maximize cash in a business.” It may be available for purchase in the training section 15. Also provided is an opt-in directory of users who may be available to provide services to other users.

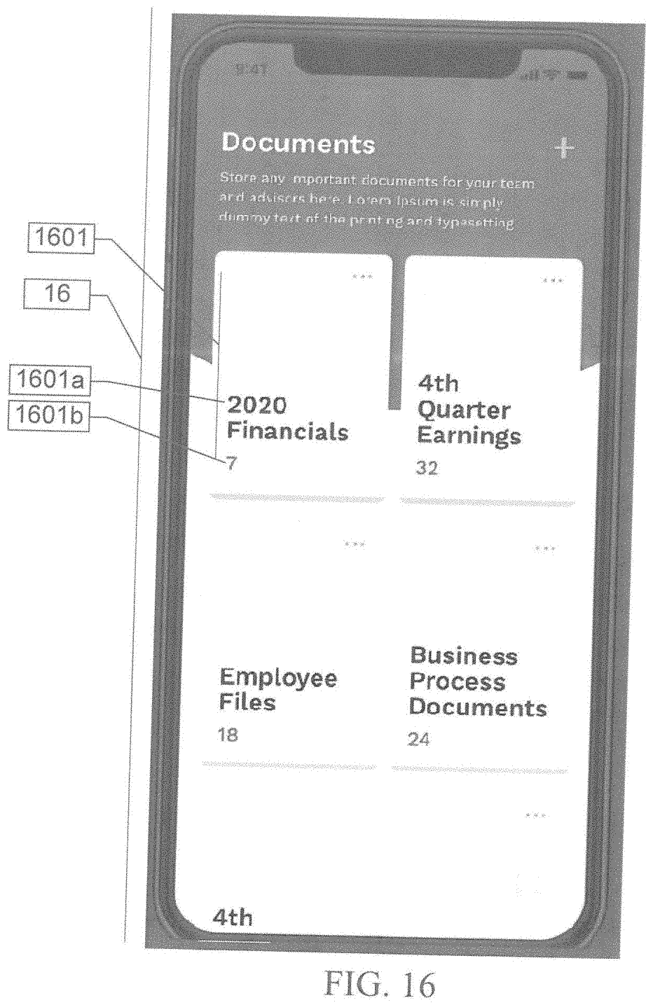

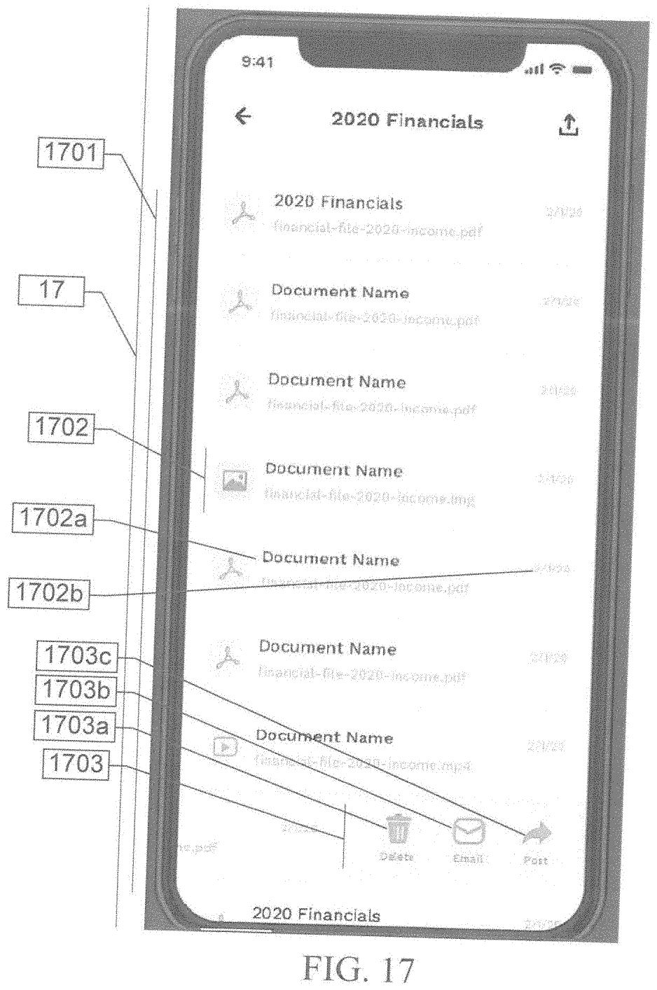

FIG. 16 and FIG. 17 are images of a document center page 16 and a document center folder list page 17. Here, a plurality of documents 1702 may be stored in a plurality of document folders 1601 which may be stored and accessed in Snopsis. The folders 1601 may have a document folder title 1601a and a document counter 1601b. The document center list page 17 shows a document list 1701. The document list 1701 may be comprised of a plurality of documents 1702. The documents 1702 may be identified with a document name 1702a and a document time stamp 1702b. The document 1702 may be controlled via a control tab 1703. The control tab 1703 features a “delete” icon 1703a, an “email” icon 1703b, and a “post” icon 1703c. The user may upload .docx, .xlsx, .pdf, or .jpeg files that may be stored in the documents page.

Preferred embodiments of the system have an architecture and design as incorporated by reference. In one of such preferred embodiments, the system is set up to process data in a series of steps:

Step 1. A primary administrator, “Admin user” may sign up for an account, complete a profile and connect to an accounting or other data source. The or “Admin user” can also invite other users to participate in the account, with varying permission levels of who can post, view, edit, delete, or create information inside the app. After an account is created, a user may login using, e.g., the user interface of FIG. 1.

Step 2. Data may be automatically gathered from the data source by the system, and normalized to be used in the analysis process. Suitably, the normalization process is automated—meaning accounts may be mapped to a bucket regardless of how an a data source or account is labeled in the customers accounting file. In one exmaple, a user may assign a label to inventory data to be “raw materials” or “Clothes”—but the system items will be normalized as inventory in the system.

Step 3. The system suitably produces the results of the analysis in a “social media” style activity feed that a client can scroll through the results. In one embodiment, the activity feed from FIG. 3 is employed.

Step 3a. At the top of the activity feed is a Milestones featurethat can be used to identify critical events that help tell the data, e.g., financial data, story of the company. In one mode, the system may identify when the value of the company increases, new sales records are achieved, new equipment is purchased, etc. Additionally, a user can use the system to identify non-fincnail events that help explain the financial data, like a New VP of Sales was hired, or an advertising campaign was a success or failure.

Step 3b. The system may suitably include a “To-Do” list that is a prominent feature on the top of the “social media” activity feed. Suitably, the “to do” list may be an automatically generated suggestion as to how to improve specific financial situations. As part of the syte , a user can select to add our suggestions to the ‘To Do” list so they can take action or assign the action to a team member. In other words, the “to do” list may require an active participation of the system, encouraging the right action at the right time. one embodiment of a to-do list is shown in FIG. 4.

Step 3c. The system may suitably calculate financial ratios for display in a “post”. In one embodiment, the post acts and responds like a social media post, where users can comment, like, or bookmark the post. In one example, a bookmarked post, may be pinned to a dashboard style board that (a) behaves like a regular business dashboard on a desktop version of the app or (b) acts like an activity feed filter in the mobile version. One embodiment of the post is shown in FIG. 5.

Step 3d. The system may suitably enable users to create their own posts. In one embodiment, this feature connects financial and non-financial users within the company whereby anyone can create a post to add text, charts, links, photos and videos. In one example, an Human resource director may tell the team about an upcoming event or benefit deadline, or the director of product acknowledging an exceptional individual effort to solve a problem. one example of a post is provided in FIGS. 6 and 7.

Step 4—the system enables accomplishing and manipulating the To-Do list. See, e.g., FIG. 8. Suitably, this aspect of the system enables (i) creation of an action for placement on the To-Do list, (ii) assignment of the action to other users or follow-up of the list status by refreshing the ratio chart associated with the action. In one instance, an action is marked completed to remove it from the list.

Step 5 the system enables creation of formulas. See, e.g., FIGS. 9 and 10. In one example, the system does not include any customized offerings or pre-loaded applications. Accordingly, a user may access their own data through the system to create any customized calculation they desire. In one exmple, a custom calculator might eliminate a need for a user to switch systems for the data or to do the calculation. In this example, a user can use the automated data calculated and collected by the system or add a customized calculation. For instance, a companies revenue can be divided by the square footage of their brick and mortor locations even though Revenue is a data recorded by Quickbooks butte the squarefootage is not. According to one aspect of the system, a customized data formula amy be saved for later use or shared to a for other.

Step 6—The system enables taking action with the Business Impact

Center. In a preferred embodiment of the styem, this step may be where locations of the businesses customers and vendors are mapped and presented so the user can see their impact. See, e.g., FIG. 11. In one mode, the mapping is time phased, wherein a user can go back in time to see growth or other trends. Also, the system may enable a user interface so that when a display of the mapped customer/vendor is chose, the system may present to the user all of the transactions with that individual, including any open transactions. See, e.g., FIG. 12. In another mode, the system may alert the mapped customer or vendor when an invoice, order or bill is due or needed. Preferably, a user can then have access to the invoice, make a call, send a reminder email, or assign an action to another user.

Step 7—The system produces Alerts and Notifications. In one operation, whenever results of the automated analysis need the users immediate attention, the results can be presented on the user interface in the form of an alert or a notification. In one mode, when the result is dire, we will alert them on their obile device to look at the result. See, e.g., FIG. 14. Otherwise, the system may include a badge counter to show notifications of interesting things, or comments aimed at the user by their is team members. See, e.g., FIG. 13.

Step 8—The system may provide access to video training program or an expert using the disclosed tools. In one example the sytem will offer a self-help video program. See, e.g., FIG. 15. Add tionaly, system offers an Opt-In directory of our Accountant users who want to help other small business users.

Step 9—The system may provide a Document Center. In this step, the system may provide the ability to store documents (e.g., FIG. 16) that are relevent to the information being discussed by a group of users. In one mode, the documents may be available for access via the system (e.g., FIG. 17).

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A software application comprising:
a login page;
an activity feed;
a to-do list;
a custom calculator; and
a saved calculations section.

2. The software application of claim 1 wherein data is gathered and mapped from an accounting data source.

3. The software application of claim 2 wherein the accounting data source is Quickbooks, Xero, or Sage50.

4. The software application of claim 3 wherein data is processed via the custom calculator or saved calculations.

5. The software application of claim 4 wherein the activity feed displays the results of data analysis.

6. The software application of claim 5 further comprising a formula matching feature.

7. The software application of claim 6 wherein the to-do list comprises a plurality of assigned actions which may be user generated or recommended by the software application.

8. A software application comprising:
data integration and mapping features;
a plurality of user profiles;
a custom calculator section;
a saved calculations section;
a training page;
a post page; and
a Business Impact Center.

9. The software application of claim 8 wherein the post page is comprised of a plurality of posts.

10. The software application of claim 9 wherein the posts are comprised of a calculation, an industry average, or a graph.

11. The software application of claim 10 wherein posts display financial ratios.

12. The software application of claim 11 wherein users' profiles are given different types of functionality.

13. The software application of claim 12 wherein the Business Impact Center features a google API map.

14. The software application of claim 13 wherein the map features vendor and customer icons superimposed on the map.

15. A method of using a software application comprising:
inputting a username and password into a login page;
mapping data from an accounting application into the software application;
processing data via a plurality of saved or preloaded formulas;
displaying a deliverable in a post on an activity feed.

16. The method of claim 15 further comprising being assigned actions.

17. The method of claim 16 further comprising actions populating in a to-do list.

18. The method of claim 17 further comprising finding an advisor via a training section.

19. The method of claim 18 further comprising watching training videos in a training section.

20. The method of claim 19 further comprising configuring the software to create a system generated post about a formula and its deliverable at a set time interval.
